(19) United States
(12) Patent Application Publication
(10) Pub. No.: US 2018/0150608 A1
(43) Pub. Date: May 31, 2018

(54) DEVICE AND METHOD FOR DIAGNOSING CARDIOVASCULAR DISEASE USING GENOME INFORMATION AND HEALTH MEDICAL CHECKUP DATA

(71) Applicant: Electronics and Telecommunications Research Institute, Daejeon (KR)

(72) Inventors: Dae Hee KIM, Daejeon (KR); Minho KIM, Daejeon (KR); YoungWon KIM, Daejeon (KR); Donghun LEE, Daejeon (KR); Myung-eun LIM, Daejeon (KR); Ho-Youl JUNG, Daejeon (KR); Jae Hun CHOI, Daejeon (KR); Youngwoong HAN, Daejeon (KR)

(73) Assignee: Electronics and Telecommunications Research Institute, Daejeon (KR)

(21) Appl. No.: 15/808,476

(22) Filed: Nov. 9, 2017

(30) Foreign Application Priority Data
Nov. 30, 2016 (KR) 10-2016-0161029
Jan. 25, 2017 (KR) 10-2017-0012278

(51) Int. Cl. G06F 19/00; G06F 19/18; G06N 99/00; G06F 19/12

(52) U.S. Cl. CPC G06F 19/345; G06F 19/12; G06N 99/005; G06F 19/18

(57) ABSTRACT

Provided are a device and method for diagnosing cardiovascular disease for providing rapid and accurate treatment and prescription for cardiovascular disease by accurately performing a diagnosis of cardiovascular disease for a particular user using the user's personal health checkup data and genome information measured periodically and the target gene of cardiovascular disease.

### CROSS-REFERENCE TO RELATED APPLICATIONS

This U.S. non-provisional patent application claims priority under 35 U.S.C. § 119 of Korean Patent Application Nos. 10-2016-0161029, filed on Nov. 30, 2016, and 10-2017-0012278, filed on Jan. 25, 2017, the entire contents of which are hereby incorporated by reference.

### BACKGROUND

The present disclosure relates to a device and method for diagnosing cardiovascular disease using genome information and health checkup data, and more particularly, to a device and method for providing rapid and accurate treatment and prescription for cardiovascular disease by accurately performing a diagnosis of cardiovascular disease for a particular user using the user's personal health checkup data and genome information measured periodically and the target gene of cardiovascular disease.

In recent years, as the level of people's living increases due to the increase in income due to industrial development and economic development, modern society is gradually entering an aging society, and the prevalence of cardiovascular disease is increasing due to changes in lifestyle and erroneous eating habits, and according thereto, the mortality rate is steadily increasing.

In general, cardiovascular disease occurs in the heart or major arteries, such as coronary artery disease. Once cardiovascular disease occurs, it has a very high mortality rate, leading to premature death and the quality of life is significantly degraded because of the cost.

In addition, the causes of cardiovascular disease include a complex combination of lifestyle habits, for example, obesity, smoking, lack of exercise, and stress, and the influence of genes found therein.

However, when cardiovascular disease is found early, it is possible to prevent the progression of cardiovascular disease through appropriate management and reduce the risk of death from disease over a lifetime. Therefore, the early and reliable diagnosis of cardiovascular disease is recognized as a very important issue in society.

To deal with this issue, a method of diagnosing cardiovascular disease using only the personal health checkup data of a user is being developed. The method for diagnosing cardiovascular disease by using health checkup data is a technique that represents cardiovascular disease occurrence possibility within 10 years as probability by reflecting only simple physical data related to lifestyle acquired through health checkup data to provide it to users.

However, the method of diagnosing cardiovascular disease using health checkup data has an issue that the accuracy and reliability are significantly low because the occurrence probability of an actual vessel disease is presented only with the user's body information, excluding the influence of a gene found in cardiovascular disease.

### SUMMARY

The present disclosure provides an accurate and reliable device and method for diagnosing cardiovascular disease by extracting SNP feature data (i.e., SNP information) of a gene from gene data and using the extracted SNP feature data of the gene and the personal health checkup data of a user.

The present disclosure also provides a device and method for rapidly diagnosing cardiovascular diseases by applying machine learning to SNP feature data and personal health checkup data and extracting the features of the SNP feature data and the personal health checkup data to reduce the number of the features of the SNP feature data and the personal health checkup data.

An embodiment of the inventive concept provides a cardiovascular disease diagnosis device including: a gene data learning unit configured to learn by using a plurality of gene data; a health checkup data learning unit configured to learn by using a plurality of health checkup data; and an integration learning unit configured to integrate and learn a learning result of the gene data and the health checkup data to generate a prediction model.

In an embodiment, the integration learning unit and the health checkup data learning unit recursively may perform learning and reflect a learning result of a specific learning operation to a previous learning operation to improve learning performance

In an embodiment, the gene data learning unit may extract Single Nucleotide Polymorphism (SNP) feature data from the plurality of gene data and learn the extracted SNP feature data.

In an embodiment, the health checkup data learning unit may convert the plurality of health checkup data into a two-dimensional binary image to allow a numerical value for a feature of the plurality of health checkup data to have a value of 0 and 1 and learn the plurality of health checkup data converted into the two-dimensional binary image.

In an embodiment, the cardiovascular disease diagnosis device may further include an SNP extraction unit configured to collect gene data for each cardiovascular disease and extract SNP position information for each of the collected gene data, wherein the SNP feature data may generated by referring the extracted SNP position information.

In an embodiment, the cardiovascular disease diagnosis device may further include a user interface unit configured to receive query data including user's personal health data and gene data, wherein the cardiovascular disease diagnosis device may convert the inputted user's personal health data into a two-dimensional binary image and extract SNP feature data from the user's genome data by referring to the stored each SNP position information.

In an embodiment, the cardiovascular disease diagnosis device may further include a cardiovascular disease prediction unit configured to input the user's personal health data converted into the two-dimensional binary image and the extracted SNP feature data to the generated prediction model to output a diagnosis result for each cardiovascular disease.

In an embodiment of the inventive concept, provided is a cardiovascular disease diagnosis method including: a gene data learning operation for learning by using a plurality of gene data; a health checkup data learning operation for learning by using a plurality of health checkup data; and an integration learning operation for integrating and learning a learning result of the gene data and the health checkup data to generate a prediction model.

In an embodiment, the integration learning operation and the health checkup data learning operation recursively may perform learning and reflect a learning result of a specific learning operation to a previous learning operation to improve learning performance.

In an embodiment, the gene data learning operation may extract Single Nucleotide Polymorphism (SNP) feature data from the plurality of gene data and learn the extracted SNP feature data.

In an embodiment, the health checkup data learning operation may convert the plurality of health checkup data into a two-dimensional binary image to allow a numerical value for a feature of the plurality of health checkup data to have a value of 0 and 1 and learn the plurality of health checkup data converted into the two-dimensional binary image.

In an embodiment, the cardiovascular disease diagnosis method may further include an SNP extraction operation for collecting gene data for each cardiovascular disease and extract SNP position information for each of the collected gene data, wherein the SNP feature data may be generated by referring the extracted SNP position information.

In an embodiment, the cardiovascular disease diagnosis method may further include a user query data input operation for receiving query data including user's personal health data and gene data, wherein the cardiovascular disease diagnosis method may convert the inputted user's personal health data into a two-dimensional binary image and extract SNP feature data from the user's genome data by referring to the stored each SNP position information.

In an embodiment, the cardiovascular disease diagnosis method may further include a cardiovascular disease prediction operation for inputting the user's personal health data converted into the two-dimensional binary image and the extracted SNP feature data to the generated prediction model to output a diagnosis result for each cardiovascular disease.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a conceptual diagram for schematically explaining a cardiovascular disease diagnosis device and method using genome data and health checkup data according to an embodiment of the inventive concept;

FIG. 2 is a view illustrating a method of imaging personal health checkup data of a user according to an embodiment of the inventive concept;

FIG. 3 is a view for explaining a method of searching for a protein generated for each gene using cardiovascular disease target gene data according to an embodiment of the inventive concept;

FIG. 4A is a view illustrating a result of searching a UCSC Known Gene database using protein ID information according to an embodiment of the inventive concept;

FIG. 4B is a view illustrating a schema of a UCSC Known Gene database according to an embodiment of the inventive concept;

FIG. 5 is a view for explaining a method for extracting SNP feature data from gene data for learning by obtaining SNP position information of cardiovascular disease target gene data according to an embodiment of the inventive concept;

FIG. 6 is a view illustrating a learning process according to an embodiment of the inventive concept;

FIG. 7 is a block diagram illustrating a configuration of a cardiovascular disease diagnosis device according to an embodiment of the inventive concept;

FIG. 8 is a flowchart illustrating a procedure of labeling and storing SNP position information for each cardiovascular disease target gene data according to an embodiment of the inventive concept; and

FIG. 9 is a flowchart illustrating a procedure for diagnosing cardiovascular disease for a user based on query data inputted from a corresponding user according to an embodiment of the inventive concept.

### DETAILED DESCRIPTION

Hereinafter, preferred embodiments of the inventive concept will be described in detail with reference to the accompanying drawings. Like reference numerals in each drawing denote like elements.

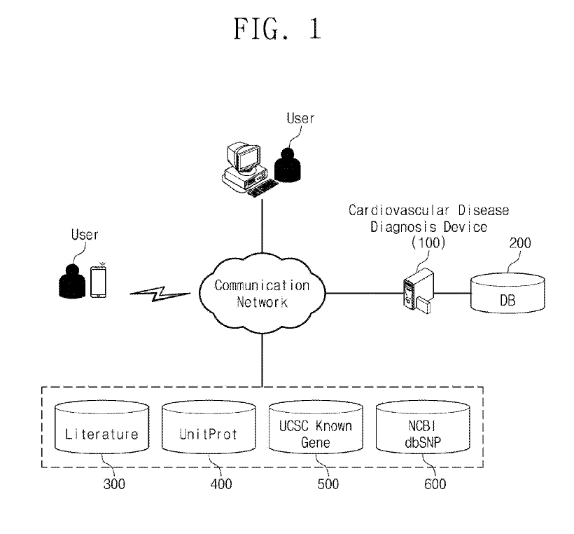

FIG. 1 is a conceptual diagram for schematically explaining a cardiovascular disease diagnosis device and method using whole information and health checkup data according to an embodiment of the inventive concept.

As shown in FIG. 1, the cardiovascular disease diagnosis device 100 periodically collects gene data and health checkup data of a person suffering from cardiovascular disease currently or previously.

In addition, the collected gene data and health checkup data are learning data for generating a prediction model for predicting cardiovascular disease of a specific user.

The gene data and the health checkup data may be provided by a hospital or a government agency, and may be collected by direct accessing a database provided in a hospital or a government agency, or collected by request.

Also, the cardiovascular disease diagnosis device 100 generates a cardiovascular disease prediction model by learning the collected gene data and health checkup data, and predicts the cardiovascular disease of a specific user based on the genome data and the personal health checkup data of the specific user, thereby performing diagnosis early.

In addition, the cardiovascular disease diagnosis device 100 converts the collected health checkup data into a two-dimensional binary monochrome image, extracts SNP feature data from the collected gene data, and learns the converted health checkup data and SNP feature data in order to generate the cardiovascular disease prediction model.

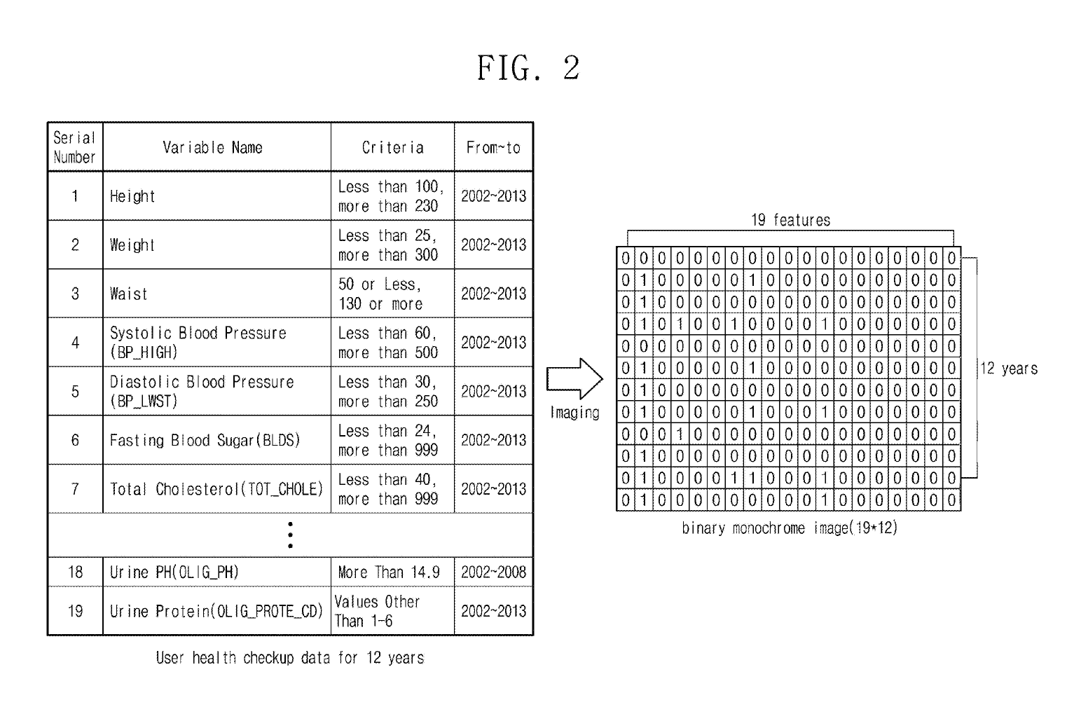

On the other hand, a method of converting the health checkup data into a two-dimensional binary monochrome image will be described in detail with reference to FIG. 2.

In addition, in order to extract SNP feature data from the collected gene data for learning, SNP position information on cardiovascular disease specific gene data is required, which is generated based on cardiovascular disease target gene data.

Therefore, the cardiovascular disease diagnosis device 100 preferentially establishes a cardiovascular disease gene list database 200 for generating SNP position information of closely related gene data for each cardiovascular disease.

The cardiovascular disease gene list database 200 accesses a literature database 300 and collects cardiovascular disease target gene data in a predetermined period through a literature search.

The literature database 300 includes a genetic association database (GAD), a literature-derived human gene-disease network (LHGDN), a befree data (BFD), or a combination thereof.

The literature database 300 is a database for storing gene lists for various diseases including a cardiovascular disease related gene list.

The cardiovascular disease diagnosis device 100 periodically accesses the literature database 300 to collect and store gene data closely related to a specific cardiovascular disease such as hypertension, atherosclerosis, myocardial infarction, and angina pectoris.

Also, the cardiovascular disease diagnosis device 100 accesses a Uniprot database 400, a UCSC know gene database 500, and an NCBI dbSNP database 600 to obtain SNP position information on the gene data related to the cardiovascular disease. The stored SNP position information becomes reference data for extracting SNP feature data from the gene data for the learning.

On the other hand, the reason for obtaining and storing the SNP position information is that human genome data (e.g., DNA) is represented by a base, which is about 3 billion. The majority of them are similar to most people, and among them, different bases occur in 1 in about 1000, which is called single nucleotide polymorphism (SNP).

Therefore, diagnosis of cardiovascular disease using human genome data has an issue that the computational complexity and time complexity are close to infinity because the amount of data is too large. The cardiovascular disease diagnosis device 100 uses only gene data related to cardiovascular disease and extracts SNP position information from corresponding gene data to diagnose cardiovascular disease. Generally, the number of bases for one gene is about 23,000, of which about 23 are represented by SNPs.

Also, when query data including user's personal health data and genome data is input, since the user's personal health checkup data includes a plurality of features (for example, blood glucose, blood pressure, family history, cholesterol, etc.), the cardiovascular disease diagnosis device 100 converts the personal health checkup data into a binary image for rapid diagnosis and extracts the features of personal health checkup data by applying a machine learning technique to the converted binary image, thereby reducing the total number of features needed for diagnosis.

Also, the cardiovascular disease diagnosis device 100 extracts SNP feature data from the user's genome data using SNP position information on the stored cardiovascular disease specific gene data.

In addition, the cardiovascular disease diagnosis device 100 may derive the cardiovascular disease prediction result for a corresponding user and provides it to a user by inputting the personal health checkup data that reduces the number of features and the extracted SNP feature data into the generated cardiovascular disease prediction model.

On the other hand, the prediction result is calculated as a probability value (i.e., having a value of 0 to 1) for each cardiovascular disease.

In addition, the cardiovascular disease diagnosis device 100 may be constructed in a hospital providing cardiovascular disease related services or as a cloud server or a platform server on the Internet in order to allow a user access the cardiovascular disease diagnosis device 100 through a wired or wireless communication network and receive cardiovascular disease diagnosis services. At this time, the user inputs his personal health data and genome data to the cardiovascular disease diagnosis device 100 for receiving a cardiovascular disease diagnosis service.

FIG. 2 is a view illustrating a method of imaging personal health checkup data of a user according to an embodiment of the inventive concept.

As shown in FIG. 2, the personal health checkup data of the user is an example of health checkup data that is generally obtained at the time of health checkup, and includes features (e.g., a variable name), criteria for feature, and year specific feature numerical values. In addition, features such as smoking, drinking, etc., which are not represented by numerical values, may be added.

In addition, the cardiovascular disease diagnosis device 100 also converts the user's personal health checkup data into a two-dimensional image.

The horizontal axis of the two-dimensional image is defined by a plurality of features shown in the personal health checkup data, and the vertical axis is defined by annual data.

In addition, if the numerical value for each feature belongs to a reference value range (i.e., a normal range), the annual data for a corresponding feature is set to 0, and if it is out of the reference value range (i.e., an abnormal range), the annual data is set to 1.

As shown in FIG. 2, if personal health checkup data is data measured from 2002 to 2013 for 19 features, it may be converted into an image having a size of 19 in width and 12 in height with a total of 12 years of data. That is, the personal health checkup data for each user is converted into a two-dimensional binary monochrome image of 19*12 and generated.

Then, the cardiovascular disease diagnosis device 100 reduces the number of features of the personal health checkup data by extracting features as applying convolution and pulling techniques of Convolutional Neural Network (CNN) to the personal health checkup data converted into the image. Through this, personal health checkup data for the plurality of patients and genome information of a corresponding patient are learned in order to perform rapid diagnosis of cardiovascular disease by using personal health checkup data of which number of features is reduced, without using the features of all health checkup data.

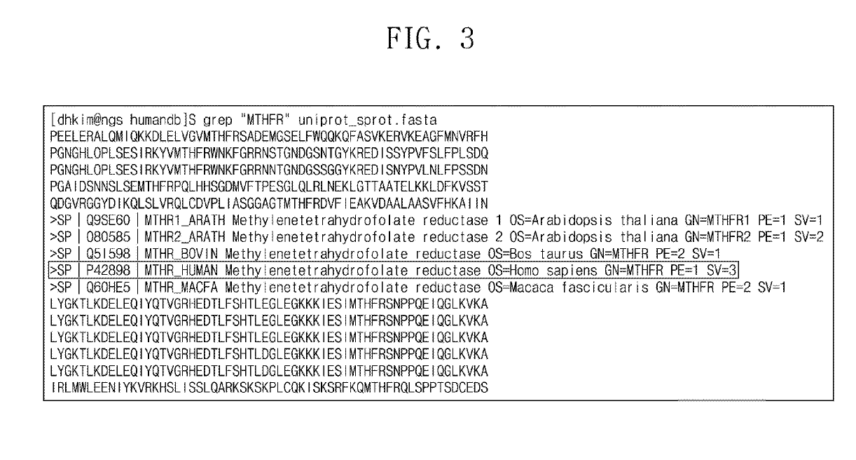

FIG. 3 is a view for explaining a method of searching for a protein generated for each gene using cardiovascular disease target gene data according to an embodiment of the inventive concept.

As shown in FIG. 3, the protein ID information of corresponding gene data may be extracted by accessing the UniProt database 400 to search for a protein generated by specific cardiovascular disease target gene data.

For example, when a “MTHFR” gene closely related to hypertension among cardiovascular diseases is searched, protein ID information may be extracted as shown in FIG. 3. In the case of homo sapiens, protein ID information P42898 is found.

Also, the cardiovascular disease diagnosis device 100 stores the protein ID information of the searched “MTHFR” gene in the database 200.

That is, the cardiovascular disease diagnosis device 100 searches for a protein produced in a corresponding gene according to a gene closely related to each cardiovascular disease (e.g., hypertension-related gene “MTHFR” or atherosclerosis related gene “CD137” and stores protein ID information on each cardiovascular disease in the database 200.

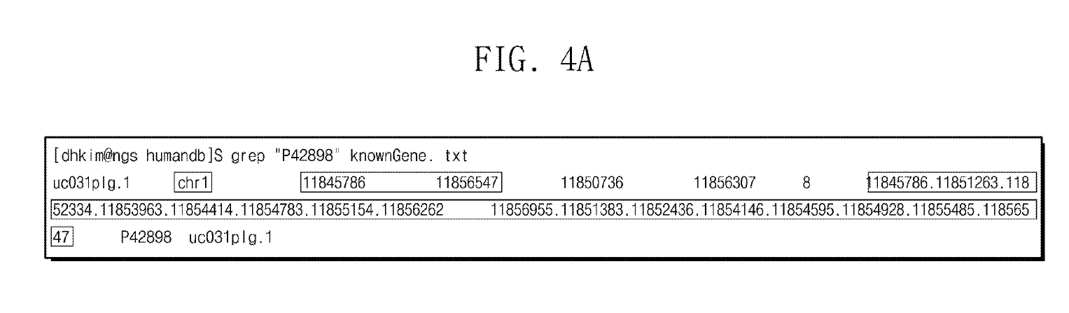

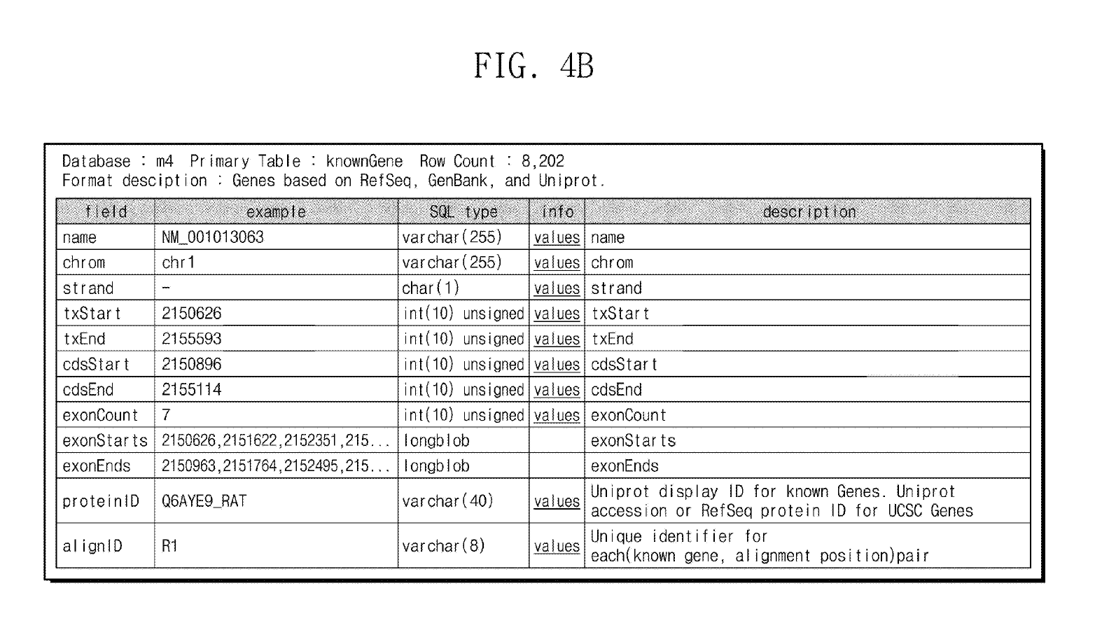

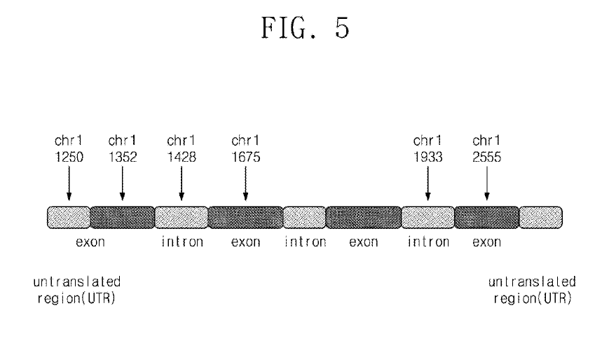

Hereinafter, the process of extracting the SNP position information of the gene data based on the protein searched using the cardiovascular disease target gene data will be described with reference to FIGS. 4 and 5.

FIG. 4A is a view illustrating a result of searching a UCSC Known Gene database using protein ID information according to an embodiment of the inventive concept.

FIG. 4B is a view illustrating a schema of a UCSC Known Gene database according to an embodiment of the inventive concept.

As shown in FIG. 4A, if the UCSC Known Gene database 500 is searched with P42898 information, which is protein ID information searched using the “MTHFR” gene data as described in FIG. 3, the UCSC Known Gene database 500 provides information on a corresponding gene in the form of a file including information on chromosome information, gene start and end positions, and exon start and end positions.

As shown in FIG. 4B, the UCSC Known Gene database 500 provides a schema for the gene, and if the search result shown in FIG. 4A is analyzed based on the provided schema for the corresponding gene, the gene occupies a portion from 11845786 to 11856547 in chr1. There are also eight exons and the first exon is located between 11845786 and 11850955 and the second exon is located between 11851263 and 11851363. In this way, a total of eight exons are located.

FIG. 5 is a view for explaining a method for extracting SNP feature data from gene data for learning by obtaining SNP position information of cardiovascular disease target gene data according to an embodiment of the inventive concept.

As shown in FIG. 5, the gene includes exons and introns. Since the gene is directly involved in protein production, the cardiovascular disease diagnosis device 100 selects the SNP in an area except introns by using the information shown in FIG. 4.

In addition, in order to search for a cardiovascular disease related gene and obtain position information on the SNP for the corresponding gene, the cardiovascular disease diagnosis device 100 searches the NCBI dbSNP database 600 and obtains the SNP position information on the corresponding gene.

The result of obtaining the position of the SNP is labeled and stored in the database (200). For example, if the result of obtaining the position of the SNP is shown like FIG. 5, except for the intron in a blue region, by labeling introns as (<chr1, 1250>, 1), (<chr1, 1352>, 2), (<chr1, 1675>, 3), (<chr1, 2555>, 4), the cardiovascular disease diagnosis device 100 generates and stores reference data (e.g., SNP position information) for extracting SNP feature data from gene data for learning.

Further, when data to be used for learning to generate a prediction model is inputted (i.e., gene data) using the result of the labeling, the cardiovascular disease diagnosis device 100 generates final learning data with reference to the label above. That is, if the position 1250 of the number chr1 is checked and data at its position is identical to human reference dielectric data (GRCh38), it is set to 0 and if not, set to 1. In such a method, SNP feature data, which is the final learning data, is generated by referring to the information at the next position and comparing it with the data to be used for the input learning to select a value.

Finally, the format of the SNP feature data extracted from the patient's genome information and used for the learning has a structure such as (1,0,0,1), (0,0,0,0) or (1,1,1,0).

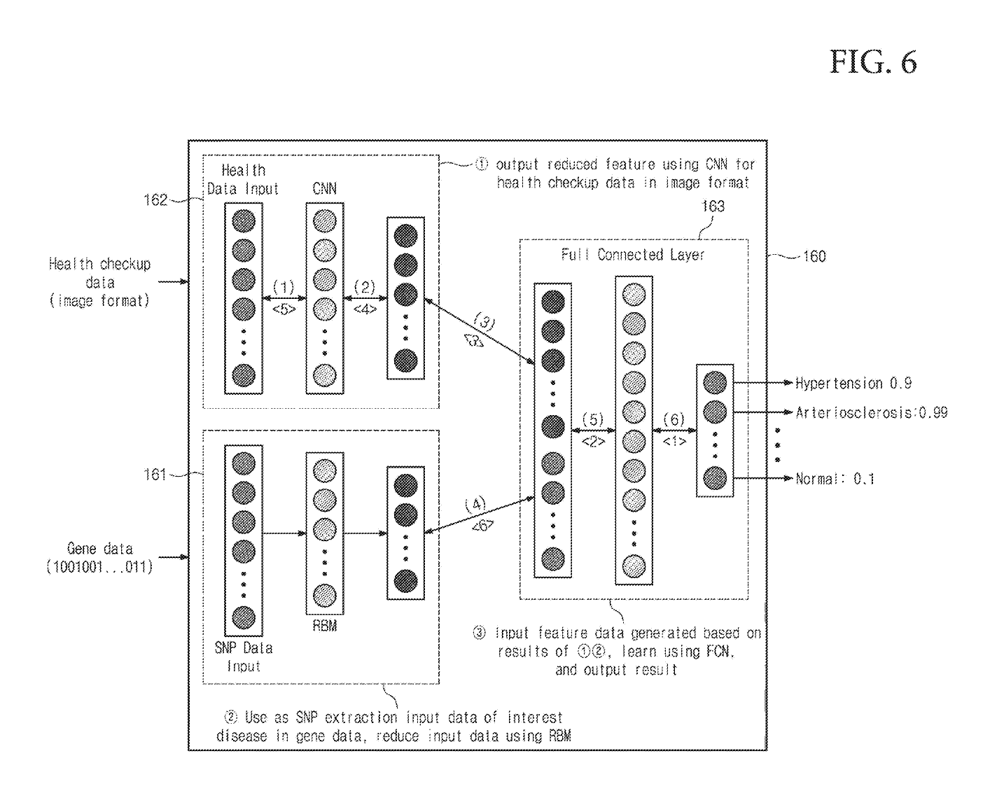

FIG. 6 is a view illustrating a learning process according to an embodiment of the inventive concept.

As shown in FIG. 6, the format of a plurality of types of health checkup data used for learning is a two-dimensional binary monochrome image, and an SNP feature data format includes 0 and 1.

In addition, the plurality of two-dimensional binary monochrome images reduce (\textcircled{1}) the number of features by using CNN, which is a machine learning technique, and the SNP feature data generates (\textcircled{2}) feature data for a final SNP that reduces input data by using a Restricted Boltzmann Machine (RBM).

Next, the cardiovascular disease diagnosis device 100 inputs the feature data generated through the processes of \textcircled{1} and \textcircled{2} into a Full Connected Layer (FCN), and outputs a prediction result learned by integrating the health checkup data and the gene data. The learning result is calculated and outputted as a probability value for each cardiovascular disease using the softmax function.

In addition, by combining result data in which the number of features of personal health checkup data is reduced through convolution, reLU, and pulling of CNN and result data in which the number of features of SNP feature data is reduced through RBM, the result is inputted the integration learning unit 163 to perform integrated learning through the FCN.

Meanwhile, the numbers ((1), (2), (3), (4), (5) and (6)) between each node are portions for calculating a weight value. an error value is generated through the processes from the number (1) to the number (6). On the other hand, the feature extraction portion of the RBM is calculated in advance regardless of the number.

Also, since the patient of the personal health checkup data used for learning is diagnosed before and already knows what type of cardiovascular disease is diagnosed, a weight value between the nodes is updated so that an accurate diagnosis is performed according to the learning result.

The update is performed using a back propagation method to correct errors according to the order of <1>, <2>, <3>, <4>, <5>, and <6>and generates a prediction model of cardiovascular disease.

When performing machine learning in a type in which an input value and a target value of a neural network through a typical error correction method of machine learning, by adjusting a weight value between each node, the back propagation method is performed in a direction of reducing an error.

The adjustment of the error detects an error while propagating from the input node to the output node and based on this, adjusts the weight value between each node while propagating back from the output node to the input node.

That is, the cardiovascular disease diagnosis device 100 recursively learns health checkup data and the health checkup data and gene data and reflects learning results of a specific learning operation to a previous learning operation in order to improve learning performance, thereby enabling the generation of highly accurate and reliable prediction models.

Thereafter, when a difference between the output value and the target value converges within a specified range, the process of correcting the error through the back propagation method is terminated and a final cardiovascular disease prediction model is generated.

The result of the cardiovascular disease prediction model is outputted as a value between 0 and 1 in the case of each cardiovascular disease and if the value is closer to 1, it may be diagnosed as cardiovascular disease.

That is, as shown in FIG. 6, when the output result is 0.9 for hypertension, 0.99 for atherosclerosis, and 0.1 for normal, it may be predicted that hypertension and atherosclerosis, that is, two types of cardiovascular disease, occur, so that early diagnosis of cardiovascular disease is possible. In addition, it may be predicted that the cardiovascular disease occurs in the case of a predetermined value or more (e.g., 0.5), and the prediction result may be provided to the user.

Also, when query data is inputted from a specific user, the cardiovascular disease diagnosis device 100 predicts the occurrence probability for cardiovascular disease of a corresponding user by using the generated cardiovascular disease prediction model.

On the other hand, the query data includes the personal health checkup data of a corresponding user and the genome data of a user.

Also, the cardiovascular disease diagnosis device 100 converts the user's personal health checkup data into a two-dimensional binary image and refers to the SNP position information on the labeled and stored cardiovascular disease specific gene data in order to extract SNP feature data from the user's genome data. Also, the cardiovascular disease diagnosis device 100 inputs to the cardiovascular disease prediction model the SNP feature data extracted from the image-converted corresponding user's personal health checkup data and user' genome data in order to provide a cardiovascular disease prediction result to the user.

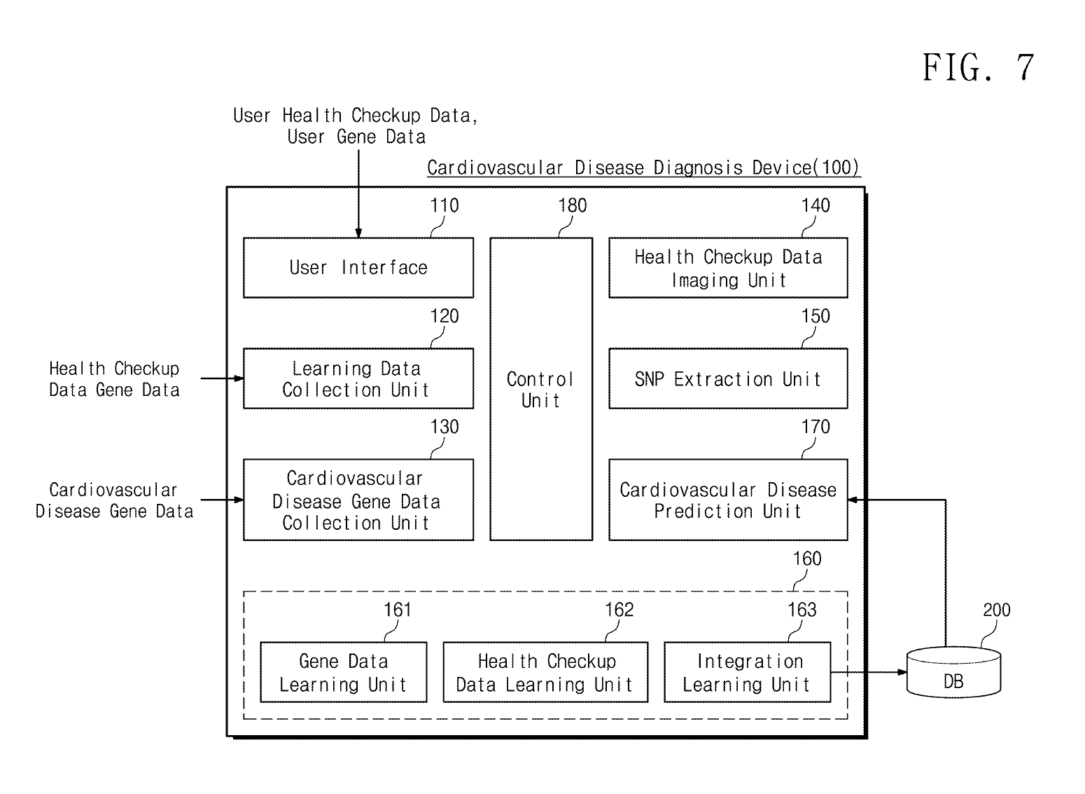

FIG. 7 is a block diagram illustrating a configuration of a cardiovascular disease diagnosis device according to an embodiment of the inventive concept.

As shown in FIG. 7, the cardiovascular disease diagnosis device 100 includes a user interface unit 110 for receiving user query data from a user, a learning data collection unit 120 for periodically collecting a plurality of health checkup data and a gene check data corresponding to the target of learning for generating a cardiovascular disease prediction model, a cardiovascular disease gene data collection unit 130 for collecting cardiovascular disease target gene data, a health checkup data imaging unit 140 for imaging the collected health checkup data, an SNP extraction unit 150 for extracting SNP position information from the collected cardiovascular disease target gene data, a learning unit 160 for learning cardiovascular disease prediction model by learning the collected checkup data and gene data, a cardiovascular disease prediction unit 170 for outputting a prediction result of cardiovascular disease to the user using the query data of the user through the generated cardiovascular disease prediction model, and a control unit 180.

In addition, the cardiovascular disease diagnosis device 100 periodically collects health checkup data and gene data of a person suffering from cardiovascular disease in the past or currently through the learning data collection unit 120 to generate a cardiovascular disease prediction model, and the cardiovascular disease target gene data is collected through the cardiovascular disease gene data collection unit 130.

In addition, the health checkup data and gene data used for the learning may be collected from domestic and overseas large hospitals, government agencies (e.g., Health Insurance Review and Evaluation Center and National Health Insurance Corporation), or individuals, and the collected health checkup data and gene data is data in which personal information (e.g., social security number) is deleted.

Also, the health checkup data imaging unit 140 converts the periodically-collected health checkup data for learning into a value of 0 and 1, which is a numerical value of the feature according to time, in order to convert the health checkup data into a two-dimensional monochrome image.

The cardiovascular disease gene data collection unit 130 also accesses the literature database 300 to collect gene data for cardiovascular diseases.

Also, the SNP extraction unit 150 extracts the position information of the SNP for each gene from the collected gene data, and generates and stores reference data for extracting the SNP feature data from the gene data for learning.

Also, the SNP extraction unit 150 extracts SNP feature data for the SNP position information from the gene data for learning using the generated reference data.

Meanwhile, the image conversion and the SNP feature data extraction are described with reference to FIGS. 2 to 5 and thus, a detailed description thereof will be omitted.

Also, the learning unit 160 includes a gene data learning unit 161 for learning the periodically-collected gene data for learning, a health checkup data learning unit 162 for learning the health checkup data for learning, and an integration learning unit 163 for generating a cardiovascular disease prediction model by integrating the results obtained through the gene data learning unit 161 and the health checkup data learning unit 162.

Also, the input of the health checkup data learning unit 162 is a learning health checkup data converted into a two-dimensional binary image, and reduces the dimension of corresponding health checkup data by extracting the number of features from the inputted health checkup data through the CNN technique.

Also, the input of the gene data learning unit 161 is SNP feature data extracted from the corresponding gene data for learning, and reduces the dimension of corresponding SNP feature data by extracting the number of features of the corresponding SNP feature data from the inputted SNP feature data through the BMS technique.

Also, the integration learning unit 153 integrates and learns the dimensionally reduced health checkup data and the SNP feature data, and through this, finally generates a cardiovascular disease prediction model.

In addition, the learning unit 160 may remove errors in the learning operation through the back propagation method to improve the accuracy of the cardiovascular disease prediction model, and since this is described above, the detailed description will be omitted.

After generating the cardiovascular disease prediction model, if a user's query data is inputted from the user, the cardiovascular disease diagnosis device 100 outputs the cardiovascular disease prediction result of the corresponding user through the cardiovascular disease prediction model and provides the user with the outputted cardiovascular disease prediction result.

Also, the user interface unit 110 provides a user interface for accessing the cardiovascular disease diagnosis device 100 to allow a user to receive a cardiovascular disease diagnosis service, and receives user query data through the user interface.

Also, the user's query data includes user's personal health checkup data of user's genome data. The health checkup data imaging unit 140 converts the inputted user's health checkup data into a two-dimensional binary monochrome image, and provides it to the disease prediction unit 170.

Also, the SNP extraction unit 150 extracts SNP feature data from the inputted user's genome data and provides it to the cardiovascular disease prediction unit 170.

Meanwhile, since a user is not able to know what kind of cardiovascular disease the user is suffering from, SNP feature data for each cardiovascular disease is extracted from the genome data of the corresponding user using the SNP position information of the stored gene data for each cardiovascular disease.

Also, when the SNP extraction unit 150 mutually compares the gene data corresponding to the SNP position information from the user's genome data with the human reference genome data, if the data are identical to each other, it is set to 0 and if not, it is set to 1, thereby generating SNP feature data to provide it to the cardiovascular disease prediction unit 170.

Also, the cardiovascular disease prediction device 170 inputs to the cardiovascular disease prediction model the personal health checkup data for a user in an image format and SNP feature data extracted from the genome of the corresponding user to output a cardiovascular disease prediction result of the corresponding user and provide it to the user.

Also, the control unit 180 controls the learning using the gene data and the health checkup data, and controls the entire operation of the cardiovascular disease diagnosis device 100 as including the data flow between components of the cardiovascular disease diagnosis device 100.

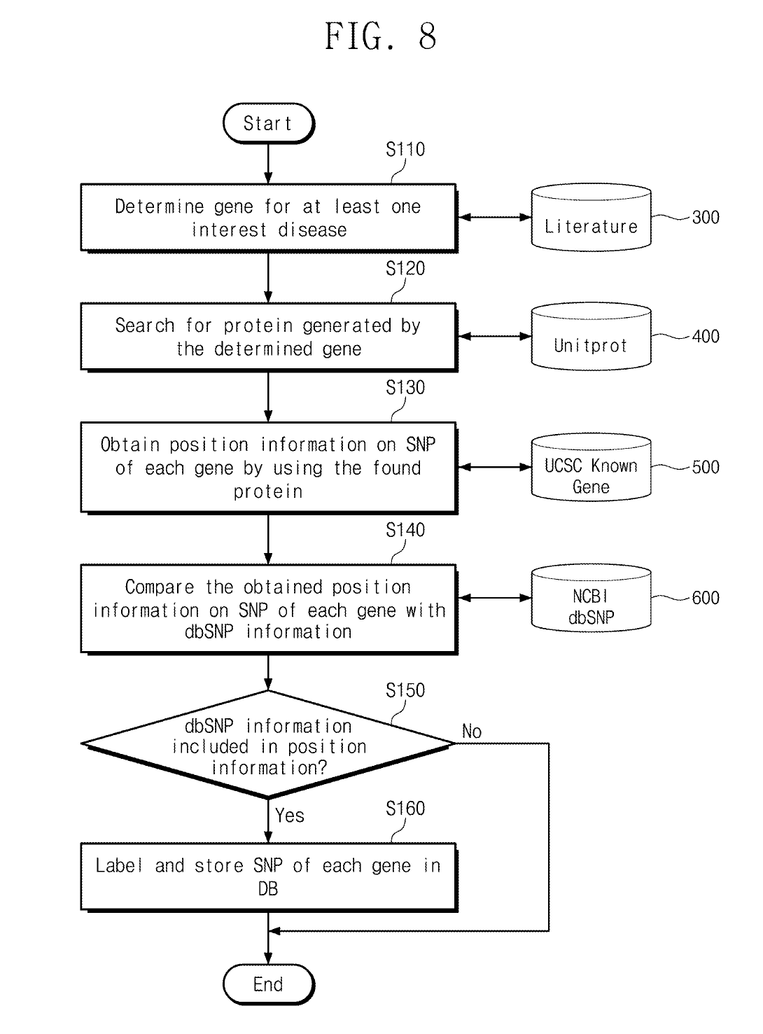

FIG. 8 is a flowchart illustrating a procedure of labeling and storing SNP position information on each cardiovascular disease target gene data according to an embodiment of the inventive concept.

As shown in FIG. 8, a procedure of labeling and storing SNP position information on each cardiovascular disease target gene data is first to search the literature database 300 and determine at least one cardiovascular disease target gene data (operation S110).

Next, a protein generated by the determined cardiovascular disease target gene is searched (S120).

The search is performed by inputting the corresponding gene into the UnitPro database 400 and extracting ID information on the protein generated by the gene.

Next, the cardiovascular disease diagnosis device 100 obtains position information on the SNP of the corresponding cardiovascular disease target gene using the ID information on the searched protein (S130).

The position information on the SNP is obtained from the UCSC Know Gene database (500).

Next, the cardiovascular disease diagnosis device 100 compares the obtained SNP position information on each gene with the dbSNP information on each corresponding gene found from the NCBI dbSNP database 600 (S140).

If the dbSNP information is included in the position information on each gene according to the comparison result (S150), the SNP position information on each gene is labeled and stored in the database 200 (S160).

That is, the cardiovascular disease diagnosis device 100 compares the SNP position information on the corresponding gene obtained from the UCSC Know Gene database 500 with the dbSNP information of the corresponding gene stored in the NCBI dbSNP database 600 in order to extract only the SNP position information corresponding to the position of the dbSNP information.

The SNP position information of each gene labeled and stored in the database 200 is reference data for generating SNP feature data by extracting SNP position information from gene data used for learning.

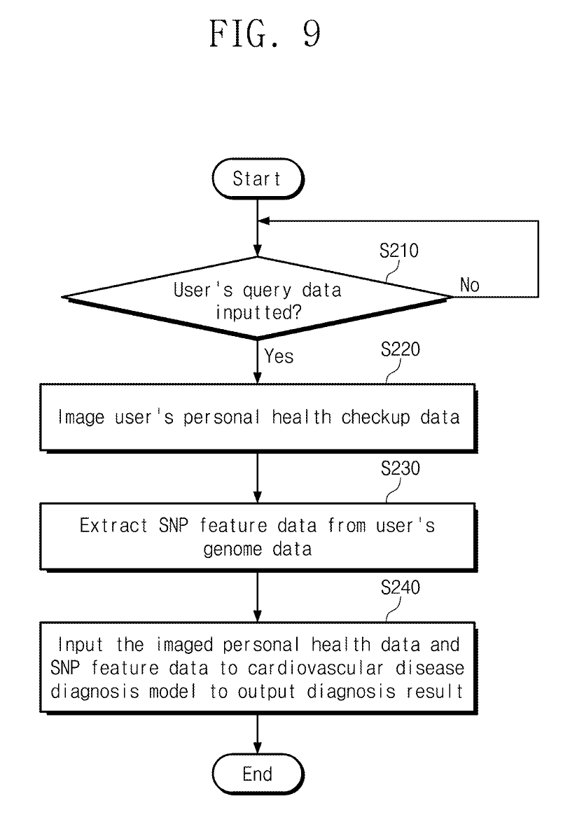

FIG. 9 is a flowchart illustrating a procedure for diagnosing cardiovascular disease for a user based on query data inputted from a corresponding user according to an embodiment of the inventive concept.

As shown in FIG. 9, when query data including personal health checkup data and genome data is inputted from a user (S210), the inputted user's personal health checkup data is converted into a two-dimensional monochrome image (S220).

In addition, the horizontal axis and the vertical axis in the monochrome image represent numerical values of time and features, and the numerical values of the features are converted to have values of 0 and 1.

Next, the cardiovascular disease diagnosis device 100 extracts SNP feature data from the user's genome data (S230).

The SNP feature data is extracted by comparing each position specific data for the user's genome data with corresponding position specific data of the human reference genome data with reference to the SNP position information on each cardiovascular disease specific gene.

Next, the cardiovascular disease diagnosis device 100 inputs to the cardiovascular disease prediction model the imaged personal health checkup data and SNP feature data and outputs and provides the prediction result to the user (S240).

The result is provided as a probability value for each cardiovascular disease. If the probability value is outputted above a predetermined value, it is diagnosed that a user likely suffers from cardiovascular disease and the diagnosis is provided to the user.

On the other hand, the cardiovascular disease prediction model reduces the number of features by applying the CNN technique to the inputted imaged personal health checkup data, and reduces the number of features by also applying the BRM technique to the SNP feature data, thereby promptly diagnosing cardiovascular disease.

As described above, unlike the typical technology for diagnosing cardiovascular disease using only health checkup data, the cardiovascular disease diagnosis device and method using genome information and health checkup data may diagnose cardiovascular disease by using genome information and health checkup data for cardiovascular disease, so that it is possible to provide a more accurate and reliable diagnosis result.

In addition, by using only minimal information (i.e., SNP feature data) among the genome information and reducing the number of features of the health checkup data, and also by generating the cardiovascular disease prediction model by learning the SNP feature data and the health checkup data that reduces the number of features, so that a quick and accurate diagnosis result may be provided to a user.

The inventive concept relates to a cardiovascular disease diagnosis device and method using genome information and health checkup data. By extracting SNP location information from gene data for cardiovascular disease, extracting SNP feature data from the genome data of the user with reference to the extracted SNP position information, and using the extracted SNP feature data and personal health checkup data of the user, the diagnosis of the cardiovascular disease of the user may be performed accurately and promptly.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A cardiovascular disease diagnosis device comprising:
a gene data learning unit configured to learn by using a plurality of gene data;
a health checkup data learning unit configured to learn by using a plurality of health checkup data; and
an integration learning unit configured to integrate and learn a learning result of the gene data and the health checkup data to generate a prediction model.

2. The device of claim 1, wherein the integration learning unit and the health checkup data learning unit recursively perform learning to reflect a learning result of a specific learning operation to a previous learning operation.

3. The device of claim 1, wherein the gene data learning unit extracts Single Nucleotide Polymorphism (SNP) feature data from the plurality of gene data and learns the extracted SNP feature data.

4. The device of claim 1, wherein the health checkup data learning unit converts the plurality of health checkup data into a two-dimensional binary image to allow a numerical value for a feature of the plurality of health checkup data to have a value of 0 and 1 and learns the plurality of health checkup data converted into the two-dimensional binary image.

5. The device of claim 3, wherein the cardiovascular disease diagnosis device further comprises an SNP extraction unit configured to collect gene data for each cardiovascular disease and extract SNP position information for each of the collected gene data,
wherein the SNP feature data is generated by referring the extracted SNP position information.

6. The device of claim 5, wherein the cardiovascular disease diagnosis device further comprises a user interface unit configured to receive query data including user's personal health data and gene data,
wherein the cardiovascular disease diagnosis device converts the inputted user's personal health data into a two-dimensional binary image and extracts SNP feature data from the user's genome data by referring to the stored each SNP position information.

7. The device of claim 6, wherein the cardiovascular disease diagnosis device further comprises a cardiovascular disease prediction unit configured to input the user's personal health data converted into the two-dimensional binary image and the extracted SNP feature data to the generated prediction model to output a diagnosis result for each cardiovascular disease.

8. A cardiovascular disease diagnosis method comprising:
learning by using a plurality of gene data;
learning by using a plurality of health checkup data; and
integrating and learning a learning result of the gene data and the health checkup data to generate a prediction model.

9. The method of claim 8, wherein the integrating and learning the learning result and the learning by using the plurality of the health checkup data comprises:
performing learning recursively to reflect a learning result of a specific learning operation to a previous learning operation.

10. The method of claim 8, wherein the learning by using the plurality of the gene data comprises:
extracting Single Nucleotide Polymorphism (SNP) feature data from the plurality of gene data; and
learning the extracted SNP feature data.

11. The method of claim 8, wherein the learning by using the plurality of the health checkup data comprises:
converting the plurality of health checkup data into a two-dimensional binary image to allow a numerical value for a feature of the plurality of health checkup data to have a value of 0 and 1; and
learning the plurality of health checkup data converted into the two-dimensional binary image.

12. The device of claim 10, wherein the cardiovascular disease diagnosis method further comprises:
collecting gene data for each cardiovascular disease; and
extracting SNP position information for each of the collected gene data,
wherein the SNP feature data is generated by referring the extracted SNP position information.

13. The device of claim 12, wherein the cardiovascular disease diagnosis method further comprises:
receiving query data including user's personal health data and gene data,
wherein the inputted user's personal health data is converted into a two-dimensional binary image and SNP feature data is extracted from the user's genome data by referring to the stored each SNP position information.

14. The device of claim 13, wherein the cardiovascular disease diagnosis method further comprises:
inputting the user's personal health data converted into the two-dimensional binary image and the extracted SNP feature data to the generated prediction model to output a diagnosis result for each cardiovascular disease.
